(19) United States
(12) Patent Application Publication
(10) Pub. No.: US 2026/0178104 A1
(43) Pub. Date: Jun. 25, 2026

(54) Common Microcontroller for Programming Multi Channel Memory Controllers

(71) Applicant: Google LLC, Mountain View, CA (US)

(72) Inventors: Aruna Kumar Tripathy, Hyderabad (IN); Jen-Kai Cho, New Taipei City (TW)

(21) Appl. No.: 18/989,502

(22) Filed: Dec. 20, 2024

(51) Int. Cl. G06F 1/3234

(52) U.S. Cl. CPC G06F 1/3275; G06F 1/3243

(57) ABSTRACT

The technology is generally directed to multi-channel memory in a system on chip (SoC) device. Multiple memory channels are associated with a single common microcontroller instead of including a microcontroller with each channel. The common microcontroller is located centrally on the chip along with the memory subsystem. The single microcontroller receives commands from a plurality of host processing entities (PEs) including one or more of a central processing unit, a debugging architecture, and a power manager The processor receives commands from the host PEs from a software sequencer of the compute device, while the single microcontroller communicates with each of the plurality of memory channels through an advanced peripheral bus. The single microcontroller aggregates requests from the host PEs and manages the programming of the memory controller, the PHY, and the dynamic random access memory for the plurality of memory channels.

### BACKGROUND

Multi-channel memory enabled devices offer improved memory performance. However, each memory channel utilizes a dedicated memory controller (MC), physical layer (PHY) and dynamic random access memory (DRAM). Additionally, the PHY includes a microcontroller that enables the PHY to train the DRAM. In system on chip (SoC) devices, chip space and power consumption are important considerations. Increased power consumption reduces battery life to power devices, and the replication of memory channel components uses chip space that could be used for other components. Implementing multi-channel memory with lower spatial requirements and operation at reduced power is desirable.

### SUMMARY

The technology is generally directed to multi-channel memory compute devices implemented as a system on chip (SoC). Power requirements and chip space are important considerations in chip design. Implementing a common microcontroller to control memory operations across multiple memory channels. Reducing the number of microcontrollers needed reduces the space needed and reduces the power requirements of multiple microcontrollers.

According to the described technology, a compute device having a plurality of memory channels includes a computer processor, a memory in communication with the processor, the memory comprising a plurality of memory channels with a plurality of dynamic random access memories (DRAMs) corresponding to each of the plurality of memory channels, a plurality of physical layers (PHY) corresponding to each of the plurality of memory channels, and a single memory microcontroller in common communication with the plurality of memory channels. The compute device can be a system on chip (SoC) device. The device may include four memory channels. The single microcontroller receives commands from a plurality of host processing entities (PEs) including one or more of a central processing unit (CPU), a debug controller, and a power manager. The processor receives commands from the host PEs from a software sequencer of the compute device, while the single microcontroller communicates with each of the plurality of memory channels through an advanced peripheral bus (APB). The single microcontroller is collocated with a memory sub-system (MEMSS) of the SoC and includes an SoC interface. The single microcontroller aggregates requests from the host PEs and manages the programming of the MC, the PHY, and the DRAM for the plurality of memory channels.

The PHY and DRAM of the plurality of memory channels can communicate with PEs of the compute device other than the single microcontroller via the APB.

In another aspect of the described technology, a method for conserving space or power consumption in a system on chip (SoC) device includes defining a plurality of memory channels of the SoC device, a memory channel of the plurality of memory channels comprising a physical layer (PHY) and a dynamic random access memory (DRAM) and providing a single microcontroller for controlling all of the plurality of memory channels. Communication between the single microcontroller and a plurality of host processing elements (PEs) via a software sequencer of the SoC device. The single microcontroller communicates with the plurality of memory channels via an advanced peripheral bus (APB) of the SoC device, while communication between the plurality of memory channels and PEs of the SoC device via the APB of the SoC device. The single microcontroller can be centrally located within the SoC device, collocated with a memory sub-system (MEMSS) of the SoC. The memory controller (MC), the PHYs of the plurality of memory channels, and the DRAMs of the plurality of memory channels can be programmed using the single microcontroller.

### BRIEF DESCRIPTION OF THE DRAWINGS

FIG. 1 is a block diagram of a multi-channel compute device according to aspects of the described technology.

FIG. 2 is a block diagram of a multi-channel compute device with a common memory microcontroller according to aspects of the described technology.

FIG. 3 is a plan view of a chip hosting a multi-channel compute device according to aspects of the described technology.

FIG. 4 is a block diagram of an example compute system according to aspects of the described technology.

### DETAILED DESCRIPTION

Current generations of memory controllers, such as those found in a system on chip (SoC) device, replicate a microcontroller along with instruction closely coupled memory (ICCM) and data closely coupled memory (DCCM) for instructions and data, respectively for each memory channel. It is less efficient considering chip area and power cost implications. The described technology presents a centralized programming model that complies with memory requirements without the need for duplication of components in multiple memory channels.

According to the described technology, one single double data rate (DDR) microcontroller having an SoC interface is provided. The single microcontroller receives programming commands from host processing elements (PEs) such as a central processing unit (CPU), power manager and debug controller. The common microcontroller aggregates requests from the host PEs and manages the programming in the MC, the physical layer (PHY) and the dynamic random access memory (DRAM) of each memory channel. The common microcontroller provides for all memory channels, services such as DDR training, DDR runtime management, power, security, quality of service (QoS), debugging and other operations.

In conventional products the MC is programmed via the PEs using advanced peripheral bus (APB) access. The PHY includes a multiplexor (MUX) to select programming either from the host or from the PHY microcontroller. The PHY microcontroller access the PHY during cold boot training, quick boot training and mission firmware during dynamic voltage and frequency scaling (DVFS). Other programming, including low power, crash reset, etc., is managed by the host memory controller.

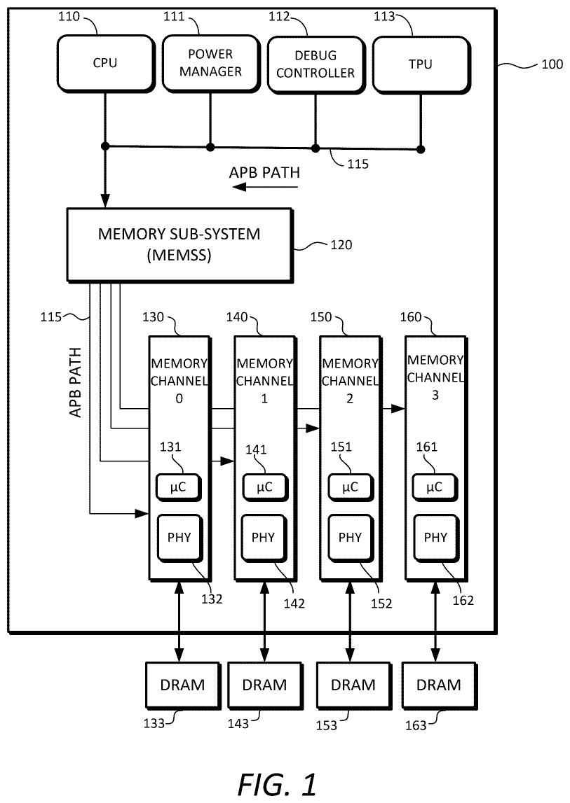

FIG. 1 is a block diagram of an SoC device 100 having multi-channel memory. Device 100 includes four memory channels 130, 140, 150, 160. Each memory channel 130, 140, 150, 160 includes a microcontroller 131, 141, 151, 161, a physical layer (PHY) 132, 142, 152, 162, and a dynamic random access memory (DRAM) 133, 143, 153, 163. Host processing elements (PEs) including central processing unit (CPU) 110, power manager (CPM) 111, debug controller 112, and tensor processing unit (TPU) 113. Host PEs communicate with the memory subsystem (MEMSS) 120 using the advanced peripheral bus (APB) 115. Host PEs provide instructions for each memory channel 130, 140, 150, 160 via APB 115, which are managed and executed by the corresponding microcontroller 131, 141, 151, 161. The number of microcontrollers 131, 141, 151, 161 is equal to the number of memory channels 130, 140, 150, 160. In the configuration of FIG. 1, the SoC device 100 must provide chip space for four microcontrollers 131, 141, 151, 161. Furthermore, each microcontroller consumes power which reduces the battery life of the device 100.

Although the microcontrollers 131, 141, 151, 161 operate in parallel, this parallel operation does not create efficiencies as each host must wait for all channels to finish each operation before issuing another instruction.

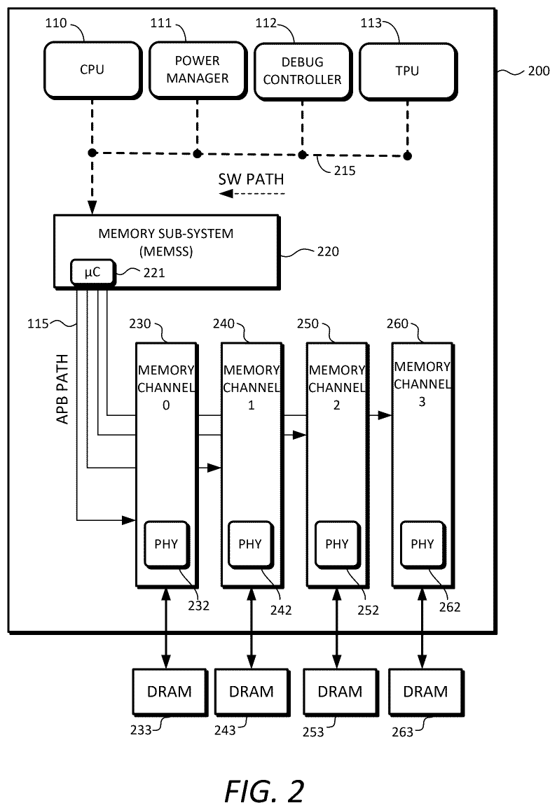

FIG. 2 is a block diagram of an SoC device 200 having multi-channel memory. Device 200 includes four memory channels 230, 240, 250, 260. Each memory channel 230, 240, 250, 260 includes a PHY 232, 242, 252, 262, and a DRAM 233, 243, 253, 263. Host PEs including CPU 110, CPM 111, host MC 112, and TPU 113. MEMSS 220 includes a common microcontroller 221. Common microcontroller 221 manages all memory channels 230, 240, 250, 260. Host PEs communicate with the MEMSS 220 using the software sequencer 215. Host PEs provide instructions for each memory channel 230, 240, 250, 260 via APB 115. The number of microcontrollers 131, 141, 151, 161 is equal to the number of memory channels 130, 140, 150, 160. In the configuration of FIG. 2, the SoC device 200 must provide chip space for only one memory microcontroller 221, thus saving space and the power needed to operate only one microcontroller.

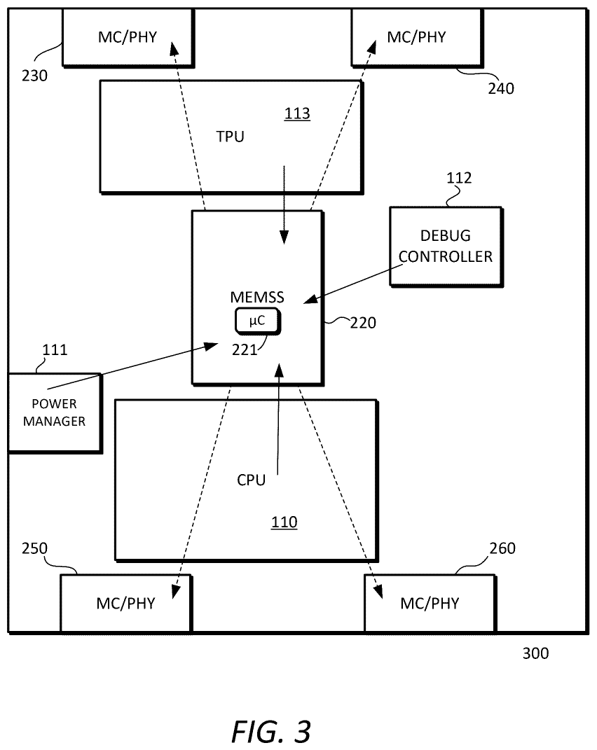

FIG. 3 is a plan view of an SoC chip 300 with a common memory microcontroller according to aspects of the described technology. Memory subsystem 220 is located near the center of the chip 300. Common microcontroller 221 is placed with the MEMSS 220 approximately equidistant from each memory channel 230, 240, 250, 260. Common microcontroller 221 receives instructions from host PEs including CPU 110, power manager 111, debug controller 112, and TPU 113. The common microcontroller 221 includes an SoC interface to receive programming from host PEs 110, 111, 112, 113. Common microcontroller 221 aggregates the instructions from the host PEs and manages the programming of the memory in channels 230, 240, 250, 260. The common microcontroller 221 can manage memory related tasks such as DDR training, DDR runtime management, power, security, QoS, debug and scan2mem. Centrally locating the common microcontroller 221 controls latency in host side communications to the common microcontroller 221, which assists in meeting QoS requirements in sufficient time.

The common microcontroller 221 implementation can save up to three times the space of the single microcontroller 221. As memory microcontrollers are in use during active mode operation, power savings are achieved in both active and idle states. These efficiencies are gained without negative impact from removal of the microcontroller in each channel. For reading operations, each host PE waits for all channels to complete the operation. Through broadcast write operations, there are little to no writing penalties over the multi microcontroller implementation.

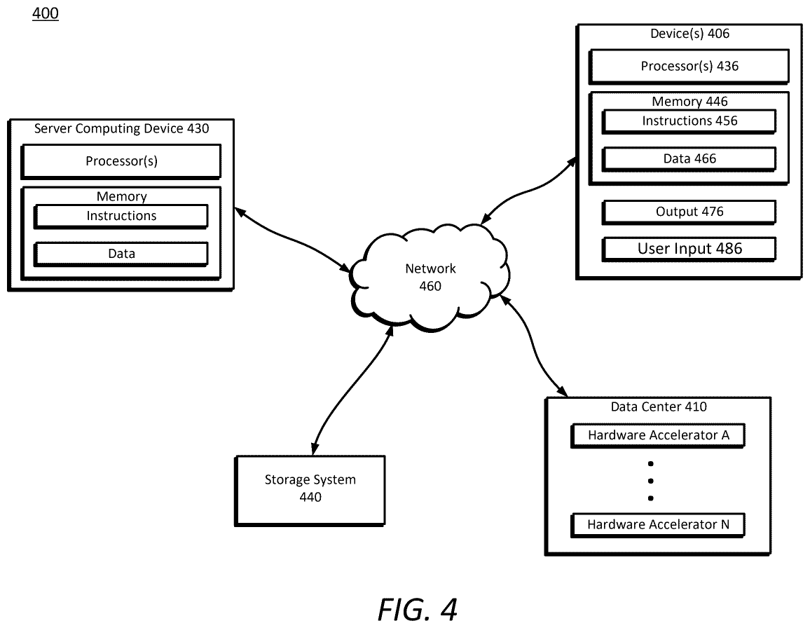

FIG. 4 illustrates an example system 400 in which the features described above may be implemented. It should not be considered limiting the scope of the disclosure or usefulness of the features described herein. In this example, system 400 may include device(s) 406, server computing device 430, storage system 440, and network 460.

Each device 406 may be a personal computing device intended for use by a respective user. The device 406 may include one or more processors 436, memory 446, data 466 and instructions 456. Each device 406 may also include an output 476, user input 486, and location sensor 496. By way of example only, devices 406 may be mobile phones or devices such as a wireless-enabled PDA, smartphones, a tablet PC, a wearable computing device (e.g., a smartwatch, AR/VR headset, smart helmet, etc.), a netbook that is capable of obtaining information via the Internet or other networks, or a smart home device, such as a home assistant, smart thermostat, smart doorbell, smart light, etc.

Memory 446 of device 406 may store information that is accessible by processor 436. Memory 446 may also include data that can be retrieved, manipulated or stored by the processor 436. The memory 446 may be of any non-transitory type capable of storing information accessible by the processor 436, including a non-transitory computer-readable medium, or other medium that stores data that may be read with the aid of an electronic device, such as a hard-drive, memory card, read-only memory (“ROM”), random access memory (“RAM”), optical disks, as well as other write-capable and read-only memories. Memory 446 may store information that is accessible by the processors 436, including instructions 456 that may be executed by processors 436, and data 466.

Data 466 may be retrieved, stored or modified by processors 436 in accordance with instructions 456. For instance, although the present disclosure is not limited by a particular data structure, the data 466 may be stored in computer registers, in a relational database as a table having a plurality of different fields and records, XML documents, or flat files. The data 466 may also be formatted in a computer-readable format such as, but not limited to, binary values, ASCII or Unicode. By further way of example only, the data 466 may comprise information sufficient to identify the relevant information, such as numbers, descriptive text, proprietary codes, pointers, references to data stored in other memories (including other network locations) or information that is used by a function to calculate the relevant data.

The instructions 456 can be any set of instructions to be executed directly, such as machine code, or indirectly, such as scripts, by the processor 436. In that regard, the terms “instructions,” “application,” “steps,” and “programs” can be used interchangeably herein. The instructions can be stored in object code format for direct processing by the processor, or in any other computing device language including scripts or collections of independent source code modules that are interpreted on demand or compiled in advance. Functions, methods and routines of the instructions are explained in more detail below.

The one or more processors 436 may include any conventional processors, such as a commercially available CPU or microcontroller. Alternatively, the processor can be a dedicated component such as an ASIC or other hardware-based processor. Although not necessary, computing devices 406 may include specialized hardware components to perform specific computing functions faster or more efficiently.

Although FIG. 4 functionally illustrates the processor, memory, and other elements of devices 406 as being within the same respective blocks, it will be understood by those of ordinary skill in the art that the processor or memory may actually include multiple processors or memories that may or may not be stored within the same physical housing. Similarly, the memory may be a hard drive or other storage media located in a housing different from that of the devices 406. Accordingly, references to a processor or device will be understood to include references to a collection of processors, devices, or memories that may or may not operate in parallel.

Output 476 may be a display, such as a monitor having a screen, a touchscreen, a projector, or a television. The display 476 of the one or more computing devices 406 may electronically display information to a user via a graphical user interface (“GUI”) or other types of user interfaces. For example, as will be discussed below, display 476 may electronically display query results.

The user input 486 may be a mouse, keyboard, touch-screen, microphone, or any other type of input.

The devices 406 can be at various nodes of a network 460 and capable of directly and indirectly communicating with other nodes of network 460. Although one device is depicted in FIG. 4, it should be appreciated that a typical system can include one or more devices, with each device being at a different node of network 460. The network 460 and intervening nodes described herein can be interconnected using various protocols and systems, such that the network can be part of the Internet, World Wide Web, specific intranets, wide area networks, or local networks. The network 460 can utilize standard communications protocols, such as WiFi, Bluetooth, 4G, 5G, etc., that are proprietary to one or more companies. Although certain advantages are obtained when information is transmitted or received as noted above, other aspects of the subject matter described herein are not limited to any particular manner of transmission.

In one example, system 400 may include one or more server computing devices 430 having a plurality of computing devices, e.g., a load balanced server farm, that exchange information with different nodes of a network for the purpose of receiving, processing and transmitting the data to and from other computing devices. For instance, one or more server computing devices 430 may be a web server that is capable of communicating with the one or more client computing devices 406 via the network 460. In addition, server computing device 430 may use network 460 to transmit and present information to a user of one of the other computing devices 406.

Server computing device 430 may include one or more processors, memory, instructions, data, etc. These components operate in the same or similar fashion as those described above with respect to computing device 406.

According to some examples, the server computing device 430 may be connected over the network to a data center 410 housing any number of hardware accelerators. The data center 410 can be one of multiple data centers or other facilities in which various types of computing devices, such as hardware accelerators, are located. Computing resources housed in the data center can be specified for repeated results monitoring, including identifying repeated query results, or the like.

The server computing device 430 can be configured to receive queries from the client computing device 406 on computing resources in the data center 410. For example, the environment can be part of a computing platform configured to provide a variety of services to users, through various user interfaces and/or application programming interfaces (APIs) exposing the platform services. The variety of services can include identifying content responsive to the query, determining whether query results are repeated query results, or the like. The client computing device 406 can transmit input data associated with a query. The server computing device 430 can receive the input data and, in response, identify and provide for output query results. When identifying the query results, the server computing device 430 can generate a signature for the query results. The generated signature may be compared to other signatures associated with the query results and/or historical query signatures. Based on the comparison, the server computing device 430 can determine whether the query results are repeated query results. In examples where the query results are repeated query results, the server computing device 430 can enable one or more preventative measures.

As other examples of potential services provided by a platform implementing the environment, the server computing device can maintain a variety of models in accordance with different constraints available at the data center. For example, the server computing device can maintain different families for deploying models on various types of TPUs and/or GPUs housed in the data center or otherwise available for processing.

Aspects of this disclosure can be implemented in digital electronic circuitry, in tangibly embodied computer software or firmware, and/or in computer hardware, such as the structure disclosed herein, their structural equivalents, or combinations thereof. Aspects of this disclosure can further be implemented as one or more computer programs, such as one or more modules of computer program instructions encoded on a tangible non-transitory computer storage medium for execution by, or to control the operation of, one or more data processing apparatus. The computer storage medium can be a machine-readable storage device, a machine-readable storage substrate, a random or serial access memory device, or combinations thereof. The computer program instructions can be encoded on an artificially generated propagated signal, such as a machine-generated electrical, optical, or electromagnetic signal, which is generated to encode information for transmission to suitable receiver apparatus for execution by a data processing apparatus.

The term “configured” is used herein in connection with systems and computer program components. For a system of one or more computers to be configured to perform particular operations or actions means that the system has installed on its software, firmware, hardware, or a combination thereof that cause the system to perform the operations or actions. For one or more computer programs to be configured to perform particular operations or actions means that the one or more programs include instructions that, when executed by one or more data processing apparatus, cause the apparatus to perform the operations or actions.

The term “data processing apparatus” refers to data processing hardware and encompasses various apparatus, devices, and machines for processing data, including programmable processors, a computer, or combinations thereof. The data processing apparatus can include special purpose logic circuitry, such as a field programmable gate array (FPGA) or an application specific integrated circuit (ASIC). The data processing apparatus can include code that creates an execution environment for computer programs, such as code that constitutes processor firmware, a protocol stack, a database management system, an operating system, or combinations thereof.

The data processing apparatus can include special-purpose hardware accelerator units for implementing machine learning models to process common and compute-intensive parts of machine learning training or production, such as inference or workloads. Machine learning models can be implemented and deployed using one or more machine learning frameworks.

The term “computer program” refers to a program, software, a software application, an app, a module, a software module, a script, or code. The computer program can be written in any form of programming language, including compiled, interpreted, declarative, or procedural languages, or combinations thereof. The computer program can be deployed in any form, including as a stand-alone program or as a module, component, subroutine, or other unit suitable for use in a computing environment. The computer program can correspond to a file in a file system and can be stored in a portion of a file that holds other programs or data, such as one or more scripts stored in a markup language document, in a single file dedicated to the program in question, or in multiple coordinated files, such as files that store one or more modules, sub programs, or portions of code. The computer program can be executed on one computer or on multiple computers that are located at one site or distributed across multiple sites and interconnected by a data communication network.

The term “database” refers to any collection of data. The data can be unstructured or structured in any manner. The data can be stored on one or more storage devices in one or more locations. For example, an index database can include multiple collections of data, each of which may be organized and accessed differently.

The term “engine” refers to a software-based system, subsystem, or process that is programmed to perform one or more specific functions. The engine can be implemented as one or more software modules or components or can be installed on one or more computers in one or more locations. A particular engine can have one or more computers dedicated thereto, or multiple engines can be installed and running on the same computer or computers.

The processes and logic flows described herein can be performed by one or more computers executing one or more computer programs to perform functions by operating on input data and generating output data. The processes and logic flows can also be performed by special purpose logic circuitry, or by a combination of special purpose logic circuitry and one or more computers.

A computer or special purposes logic circuitry executing the one or more computer programs can include a central processing unit, including general or special purpose microcontrollers, for performing or executing instructions and one or more memory devices for storing the instructions and data. The central processing unit can receive instructions and data from the one or more memory devices, such as read only memory, random access memory, or combinations thereof, and can perform or execute the instructions. The computer or special purpose logic circuitry can also include, or be operatively coupled to, one or more storage devices for storing data, such as magnetic, magneto optical disks, or optical disks, for receiving data from or transferring data to. The computer or special purpose logic circuitry can be embedded in another device, such as a mobile phone, a personal digital assistant (PDA), a mobile audio or video player, a game console, a Global Positioning System (GPS), or a portable storage device, e.g., a universal serial bus (USB) flash drive, as examples.

Computer readable media suitable for storing the one or more computer programs can include any form of volatile or non-volatile memory, media, or memory devices. Examples include semiconductor memory devices, e.g., EPROM, EEPROM, or flash memory devices, magnetic disks, e.g., internal hard disks or removable disks, magneto optical disks, CD-ROM disks, DVD-ROM disks, or combinations thereof.

Aspects of the disclosure can be implemented in a computing system that includes a back end component, e.g., as a data server, a middleware component, e.g., an application server, or a front end component, e.g., a client computer having a graphical user interface, a web browser, or an app, or any combination thereof. The components of the system can be interconnected by any form or medium of digital data communication, such as a communication network. Examples of communication networks include a local area network (LAN) and a wide area network (WAN), e.g., the Internet.

The computing system can include clients and servers. A client and server can be remote from each other and interact through a communication network. The relationship of client and server arises by virtue of the computer programs running on the respective computers and having a client-server relationship to each other. For example, a server can transmit data, e.g., an HTML page, to a client device, e.g., for purposes of displaying data to and receiving user input from a user interacting with the client device. Data generated at the client device, e.g., a result of the user interaction, can be received at the server from the client device.

Unless otherwise stated, the foregoing alternative examples are not mutually exclusive but may be implemented in various combinations to achieve unique advantages. As these and other variations and combinations of the features discussed above can be utilized without departing from the subject matter defined by the claims, the foregoing description of the examples should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible implementations. Further, the same reference numbers in different drawings can identify the same or similar elements.

1. A compute device having a plurality of memory channels comprising:
a computer processor;
a memory in communication with the processor, the memory comprising a plurality of memory channels;
a plurality of dynamic random access memories (DRAMs) corresponding to each of the plurality of memory channels;
a plurality of physical layers (PHY) corresponding to each of the plurality of memory channels; and
a single memory microcontroller in common communication with the plurality of memory channels.

2. The compute device of claim 1, wherein the compute device is a system on chip (SoC) device.

3. The compute device of claim 2, wherein the plurality of memory channels comprises four memory channels.

4. The compute device of claim 1, wherein the single microcontroller receives commands from a plurality of host processing entities (PEs).

5. The compute device of claim 4, the plurality of host PEs includes one or more of a central processing unit (CPU), a debugging architecture, and a memory controller (MC).

6. The compute device of claim 4, the processor receiving commands from the host PEs from a software sequencer of the compute device.

7. The compute device of claim 6, wherein the single microcontroller communicates with each of the plurality of memory channels through an advanced peripheral bus (APB).

8. The compute device of claim 7, wherein the single microcontroller is collocated with a memory sub-system (MEMSS) of the SoC.

9. The compute device of claim 8, wherein the single microcontroller comprises an SoC interface.

10. The compute device of claim 9, the single microcontroller having access to the MC, PHY and DRAM through the software sequencer.

11. The compute device of claim 10, wherein the single microcontroller aggregates requests from the host PEs and manages the programming of the MC, the PHY, and the DRAM for the plurality of memory channels.

12. The compute device of claim 11, wherein the PHY and DRAM of the plurality of memory channels communicates with PEs of the compute device other than the single microcontroller via the APB.

13. The compute device of claim 12, wherein the single microcontroller programs the memory of the plurality of memory channels.

14. A method for conserving space or power consumption in a system on chip (SoC) device, comprising:
defining a plurality of memory channels of the SoC device, a memory channel of the plurality of memory channels comprising a physical layer (PHY) and a dynamic random access memory (DRAM);
providing a single microcontroller for controlling all of the plurality of memory channels.

15. The method of claim 14, further comprising:
communicating between the single microcontroller and a plurality of host processing elements (PEs) via a software sequencer of the SoC device.

16. The method of claim 15, further comprising:
communicating between the single microcontroller and the plurality of memory channels via an advanced peripheral bus (APB) of the SoC device.

17. The method of claim 16, further comprising:
communicating between the plurality of memory channels and PEs of the SoC device via the APB of the SoC device.

18. The method of claim 17, further comprising:
placing the single microcontroller centrally located within the SoC device.

19. The method of claim 18, further comprising:
collocating the single microcontroller with a memory sub-system (MEMSS) of the SoC device.

20. The method of claim 19, further comprising:
training a memory controller (MC) of the SoC device, the PHYs of the plurality of memory channels, and the DRAMs of the plurality of memory channels using the single.
